(19) United States
(12) Patent Application Publication
(10) Pub. No.: US 2025/0333587 A1
(43) Pub. Date: Oct. 30, 2025

(54) COMPOSITION FOR A FILM LAYER

(71) Applicant: BOREALIS AG, Vienna (AT)

(72) Inventors: Jingbo WANG, Linz (AT); Friedrich BERGER, Linz (AT); Jani AHO, Porvoo (FI); Qizheng DOU, Linz (AT)

(73) Assignee: BOREALIS AG, Vienna (AT)

(21) Appl. No.: 18/865,014

(22) PCT Filed: May 9, 2023
(86) PCT No.: PCT/EP2023/062217

§ 371 Date: Nov. 12, 2024

(30) Foreign Application Priority Data
May 12, 2022 (EP) 22172875.1

(51) Int. Cl. C08L 23/06; C08J 5/18

(52) U.S. Cl. CPC C08L 23/06; C08J 5/18; C08J 2323/08; C08J 2423/08; C08L 2203/16; C08L 2205/025; C08L 2207/20

(57) ABSTRACT

A composition is disclosed which includes a metallocene catalysed medium density polyethylene (MDPE) and a mixed-plastic-polyethylene recycling blend, with films and methods of use of the composition in film applications and films including the polymer composition.

The present invention relates to a composition comprising a metallocene catalysed medium density polyethylene (MDPE) and a mixed-plastic-polyethylene recycling blend (PERB), to the use of the composition in film applications and to a film comprising the polymer composition of the invention.

Polyolefins, in particular polyethylene and polypropylene are increasingly consumed in large amounts in a wide range of applications, including packaging for food and other goods.

Polyethylene based materials are a particular problem as these materials are extensively used in packaging. Taking into account the huge amount of waste collected compared to the amount of waste recycled back into the stream, there is still a great potential for intelligent reuse of plastic waste streams and for mechanical recycling of plastic wastes.

It is thus important to form a circular economy that brings plastic waste back to a second life, i.e., to recycle it. This not only avoids leaving plastic waste in the environment but also recovers its value.

In addition, the European Commission confirmed in 2017 that it would focus on plastics production and use. The EU goals are that 1) by 2025 at least 55% of all plastics packaging in the EU should be recycled and 2) by 2030 all plastic packaging placed in the EU market is reusable or easily recycled. This pushes the brand owners and plastic converters to pursue solutions with recyclate or virgin/recyclate blends.

Thus, there is an increasing importance to include polymers obtained from waste materials for the manufacturing of new products, i.e. wherein waste plastics (e.g. post-consumer recyclate (PCR)) can be turned into resources for new plastic products. Hence, environmental and economic aspects can be combined in recycling and reusing waste plastics material.

However, recycled plastics are normally inferior to virgin plastics in their quality due to degradation, contamination and mixing of different plastics.

In addition, compositions containing recycled polyolefin materials normally have properties, which are much worse than those of the virgin materials, unless the amount of recycled polyolefin added to the final composition is extremely low. For example, such materials often have limited impact strength and poor mechanical properties and thus, they do not fulfil customer requirements.

Blending recycled plastics with virgin plastics is a common practice of improving the quality of recycled plastics.

EP 3838984 A1 for example describes blends of a LDPE recyclate (e.g. NAV 102 from Ecoplast) with Ziegler-Natta catalysed LLDPEs or MDPEs for wire and cable applications. The amount of added recyclate is between 4.0 to 35.0 wt % based on the total composition.

WO 2020/207940 describes a multilayer collation shrink film, which has good optical surface layer properties, a good shrink behaviour and a good balance between holding force and cold shrink properties.

The core layer B is based on a blend of 70.0 wt % of recycled LDPE and 30.0 wt % of a Ziegler-Natta catalysed terpolymer (i.e. FX1002).

Film properties, like stiffness, toughness and haze are not mentioned at all.

Based on this it was one objective of the present invention to provide a polyethylene based composition allowing the use of recycled LDPE, which can be used for producing films with good properties, especially good mechanical properties such as impact and improved optics, especially haze and an improved balance between stiffness, impact and optics, especially haze.

In addition, it should be possible to add higher amounts of recyclate into the composition.

The inventors have now found that a blend of a metallocene catalysed medium density polyethylene (MDPE) having a specific polymer design and a major part of a LDPE recyclate (i.e. a mixed-plastic-polyethylene recycling blend), provides films with an improved balance between stiffness, impact and optics, i.e. haze.

### DESCRIPTION OF THE INVENTION

The present invention is therefore directed to a composition comprising
(I) 1.0 to 49.0 wt % based on the total weight of the composition of a metallocene catalysed medium density polyethylene (MDPE), wherein the metallocene catalysed MDPE has
   a density (ISO 1183) in the range of 932 to 955 kg/m³,
   a MFR₂ (190° C., 2.16 kg, ISO 1133) in the range of 0.1 to 2.0 g/10 min,
   a MFR₂₁ (190° C., 21.6 kg, ISO 1133) in the range of 10.0 to 40.0 g/10 min,
   a ratio MFR₂₁/MFR₂ (FRR) in the range of 20.0 to 60.0,
   a Mw/Mn (MWD) in the range of 2.5 to 7.0 and
   a ratio of FRR/MWD in the range of 7.5 to 11.0; and
(II) 51.0 to 99.0 wt % based on the total weight of the composition of a mixed-plastic-polyethylene recycling blend (PERB) having
   a MFR₂ (ISO 1133, 2.16 kg, 190° C.) of from 0.1 to 1.2 g/10 min,
   a density of from 910 to 945 kg/m³ and
   a total amount of ethylene units (C2 units) of from 80.0 to 96.0 wt %, as measured by NMR of the d2-tetrachloroethylene soluble fraction,
   with the total amount of C2 units being based on the total weight amount of monomer units in the mixed-plastic-polyethylene blend (PERB) and measured according to quantitative ¹³C{1H} NMR measurement,
whereby components (I) and component (II) of the composition add up to 100 wt %.

Unexpectedly such a composition provides films with an improved balance between stiffness, impact and optics, i.e. haze.

The invention is therefore further directed to a film comprising at least one layer comprising the above described composition.

The specific design of the metallocene catalysed medium density polyethylene (MDPE) thereby allows the addition of more recyclate, i.e. of more than 50 wt % of the composition, and still provides films with good impact/stiffness/optics balance.

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Metallocene catalysed medium density polyethylene (MDPE) is defined in this invention as medium density polyethylene, which has been produced in the presence of a metallocene catalyst.

For the purpose of the present invention “medium density polyethylene (MDPE) which comprises polyethylene component (A) and polyethylene component (B)” means that the MDPE is produced in an at least 2-stage sequential polymerization process, wherein first component (A) is produced and component (B) is then produced in the presence of component
(A) in a subsequent polymerization step, yielding the MDPE or vice versa, i.e. first component
(B) is produced and component (A) is then produced in the presence of component (B) in a subsequent polymerization step, yielding the MDPE.

MDPEs produced in a multistage process are also designated as “in-situ” or “reactor” blends.

The resulting end product consists of an intimate mixture of the polymers from the two or more reactors, the different molecular-weight-distribution curves of these polymers together forming a molecular-weight-distribution curve having a broad maximum or two or more maxima, i.e. the end product is a multimodal polymer mixture.

The term “multimodal” in context of medium density polyethylene (MDPE) means herein multimodality with respect to melt flow rate (MFR) of the at least two ethylene polymer components, i.e. the two ethylene polymer components, have different MFR values. The multimodal medium density polyethylene can have in addition or alternatively multimodality between the two polyethylene components with respect to one or more further properties, like density, comonomer type and/or comonomer content, as will be described later below.

For the purposes of the present description and of the subsequent claims, the term “mixed-plastic-polyethylene recycling blend (PERB)” indicates a polymer material including predominantly units derived from ethylene apart from other polymeric ingredients of arbitrary nature. Such polymeric ingredients may for example originate from monomer units derived from alpha olefins such as propylene, butylene, hexene, octene, and the like, styrene derivatives such as vinylstyrene, substituted and unsubstituted acrylates, substituted and unsubstituted methacrylates.

Said polymeric materials can be identified in the mixed-plastic polyethylene composition by means of quantitative ¹³C{1H} NMR measurements as described herein. In the quantitative ¹³C{1H} NMR measurement used herein and described below in the measurement methods different units in the polymeric chain can be distinguished and quantified. These units are ethylene units (C2 units), units having 3, 4 and 6 carbons and units having 7 carbon atoms.

Thereby, the units having 3 carbon atoms (C3 units) can be distinguished in the NMR spectrum as isolated C3 units (isolated C3 units) and as continuous C3 units (continuous C3 units) which indicate that the polymeric material contains a propylene based polymer. These continuous C3 units can also be identified as iPP units.

The units having 3, 4, 6 and 7 carbon atoms describe units in the NMR spectrum which are derived from two carbon atoms in the main chain of the polymer and a short side chain or branch of 1 carbon atom (isolated C3 unit), 2 carbon atoms (C4 units), 4 carbon atoms (C6 units) or 5 carbon atoms (C7 units).

The units having 3, 4 and 6 carbon atoms (isolated C3, C4 and C6 units) can derive either from incorporated comonomers (propylene, 1-butene and 1-hexene comonomers) or from short chain branches formed by radical polymerization.

The units having 7 carbon atoms (C7 units) can be distinctively attributed to the mixed-plastic-polyethylene primary recycling blend (PERB) as they cannot derive from any comonomers. 1-heptene monomers are not used in copolymerization. Instead, the C7 units represent presence of LDPE distinct for the recyclate. It has been found that in LDPE resins the amount of C7 units is always in a distinct range. Thus, the amount of C7 units measured by quantitative ¹³C{1 H} NMR measurements can be used to calculate the amount of LDPE in a polyethylene composition.

Thus, the amounts of continuous C3 units, isolated C3 units, C4 units, C6 units and C7 units are measured by quantitative ¹³C{1H} NMR measurements as described below, whereas the LDPE content is calculated from the amount of C7 units as described below.

The total amount of ethylene units (C2 units) is attributed to units in the polymer chain, which do not have short side chains of 1-5 carbon atoms, in addition to the units attributed to the LDPE (i.e. units which have longer side chains branches of 6 or more carbon atoms).

Conventionally further components such as fillers, including organic and inorganic fillers for example talc, chalk, carbon black, and further pigments such as TiO₂ as well as paper and cellulose may be present. In a specific and preferred embodiment the waste stream is a consumer waste stream, such a waste stream may originate from conventional collecting systems such as those implemented in the European Union. Post-consumer waste material is characterized by a limonene content of from 0.1 to 500 mg/kg (as determined using solid phase microextraction (HS-SPME-GC-MS) by standard addition).

The term “natural” in the context of the present invention means that the components are of natural colour. This means that no pigments (including carbon black) are included in the components of the mixed-plastic-polyethylene recycling blend of the present invention.

### DETAILED DESCRIPTION OF INVENTION

The composition of the present invention comprises
(I) 1.0 to 49.0 wt %, preferably 10.0 to 45.0 wt % and more preferably 20.0 to 40.0 wt % of a metallocene catalysed medium density polyethylene (MDPE) and
(II) 51.0 to 99.0 wt %, preferably 55.0 to 90.0 wt % and more preferably 60.0 to 80.0 wt % of a mixed-plastic-polyethylene recycling blend (PERB).

The amount of (I) and (II) add up to 100.0 wt %.

(I) Ad metallocene catalysed medium density polyethylene (MDPE)

It has been found that the metallocene catalysed medium density polyethylene according to the invention provides an improved material for film applications, which combines very good mechanical properties e.g. in terms of tensile modulus, good toughness e.g. in terms of dart drop impact with excellent optical properties e.g. in terms of haze, when added to a mixed-plastic-polyethylene recycling blend (PERB).

The metallocene catalysed MDPE used according to the present invention has a density (ISO 1183) in the range of 932 to 955 kg/m³, preferably 933 to 950 kg/m³ and more preferably 935 to 945 kg/m³.

The MFR₂ (190° C., 2.16 kg, ISO 1133) of the metallocene catalysed MDPE is in the range of 0.1 to 2.0 g/10 min, preferably 0.2 to 1.5 g/10 min, more preferably 0.3 to 1.2 g/10 min and even more preferably 0.4 to 1.0 g/10 min.

The MFR₂₁ (190° C., 21.6 kg, ISO 1133) of the metallocene catalysed MDPE is in the range of 10.0 to 40.0 g/10 min, preferably in a range of 15 to 38.0 g/10 min, more preferably in the range of 18.0 to 35.0 g/10 min and most preferably 20.0 to 33.0 g/10 min.

The metallocene catalysed MDPE used according to the present invention furthermore has a Flow Rate Ratio (FRR) of the MFR₂₁/MFR₂ in the range of 20.0 to 60.0, more preferably of 22.0 to 58.0 and more preferably of 25.0 to 55.0.

Additionally, the metallocene catalysed MDPE has a molecular weight distribution (MWD), Mw/Mn, in the range of 2.5 to 7.0, preferably 2.8 to 6.8, and more preferably 3.0 to 6.5.

The ratio of FRR/MWD of the metallocene catalysed MDPE used according to the present invention is in the range of 7.5 to 11.0, preferably 7.8 to 10.5 and more preferably 8.0 to 10.0.

In addition, the metallocene catalysed MDPE used according to the present invention may have one or more or all of the properties described now below:

### Weight Average Molecular Weight Mw

The metallocene catalysed MDPE may have a weight average molecular weight, Mw, of at least 100000 g/mol, preferably in the range of from 109000 to 150000 g/mol, more preferably from 109000 to 130000 g/mol, still more preferably from 109000 to 120000 g/mol.

### z Average Molecular Weight Mz

The z average molecular weight, Mz, may be in the range of 215000 to 400000 g/mol, preferably 230000 to 380000 g/mol and more preferably from 250000 to 350000 g/mol.

### Ratio of Mz/Mw

The ratio of Mz/Mw may be in the range of 2.0 to 4.0, preferably 2.2 to 3.5 and more preferably 2.3 to 3.2.

### Ratio FRR/(Mz/Mw)

The ratio FRR/(Mz/Mw) may be in the range of 11.5 to 20.0, preferably 11.8 to 19.0, and more preferably 12.0 to 18.5.

The metallocene catalysed MDPE may contain additives and/or fillers.

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

### Embodiment (I)

In one preferred embodiment, i.e. embodiment (I), the metallocene catalysed MDPE comprises at least
(i) 30 to 70 wt %, relative to the total weight of the MDPE, of a polyethylene component (A) with a density in the range of 950 to 980 kg/m³ and an MFR₂ (190° C., 2.16 kg, ISO 1133) of 2.0 to 500 g/10 min; and
(ii) 30 to 70 wt %, relative to the total weight of the MDPE, of a polyethylene component (B) being a polyethylene with a density in the range of 900 to 925 kg/m³ and an MFR₂ (190° C., 2.16 kg, ISO 1133) of 0.0001 to 1.0 g/10 min.

The weight ratio of polyethylene component (A) to polyethylene component (B) in the metallocene catalysed MDPE thus is in the range 30:70 to 70:30, preferably 35:65 to 65:35, more preferably 40:60 to 60:40. In some embodiments the ratio may be 35 to 50 wt % of polyethylene component (A) and 50 to 65 wt % of polyethylene component (B), such as 40 to 50 wt % of polyethylene component (A) and 50 to 60 wt % of polyethylene component (B), wherein the wt % values are relative to the total weight of the metallocene catalysed MDPE. In a particularly preferred embodiment, the wt % values for components (A) and (B) add up to 100%.

In this embodiment (I) the polyethylene component (A) and/or (B) can be a homopolymer or an ethylene copolymer.

Preferably, the MDPE can have two copolymer components or one copolymer component and one homopolymer component, thus preferably both components are an ethylene copolymer or alternatively polyethylene component (A) is a homopolymer and polyethylene component (B) is a copolymer or vice versa (polyethylene component (A) being a copolymer and polyethylene component (B) being a homopolymer). More preferably, polyethylene component (A) is a homopolymer and polyethylene component (B) is a copolymer.

In view of the present invention by polyethylene homopolymer a polymer is meant, which comprising at least 99.0 wt %, especially at least 99.5 wt % ethylene monomer units. Thus, the polyethylene homopolymer may comprise up to 1.0 wt % comonomer units, but preferably comprises only up to 0.5 wt %, like up to 0.2 wt % or even up to 0.1 wt % only.

In an embodiment of the present invention, the amount of comonomer in the polyethylene homopolymer component is not detectable with ¹³C-NMR.

Preferably, polyethylene component (B) consists of a single ethylene copolymer or of a single ethylene homopolymer, more preferably of a single ethylene copolymer. Polyethylene component (A) may consist of a single ethylene homo- or copolymer. Alternatively, polyethylene component (A) may be an ethylene polymer mixture comprising (e.g. consisting of) a first ethylene polymer fraction (A-1) and a second ethylene polymer fraction (A-2), whereby both fractions are either a homopolymer or a copolymer. Polyethylene component (A) may be unimodal or multimodal. In case polyethylene component (A) is an ethylene copolymer mixture, it is preferable if the comonomer(s) in the first and second ethylene copolymer fractions are the same.

Preferred ethylene copolymers employ alpha-olefins (e.g. C3-12 alpha-olefins) as comonomers. Examples of suitable alpha-olefins include 1-butene, 1-hexene and 1-octene. 1-butene and 1-hexene are especially preferred comonomers.

More preferably, the polyethylene component (A) is an ethylene homopolymer and the polyethylene component (B) is an ethylene-1-hexene copolymer.

The polyethylene component (A) preferably has a MFR₂ in the range of 10 to 400 g/10 min, more preferably 50 to 300 g/10 min, and even more preferably 100 to 200 g/10 min.

The density of polyethylene component (A) preferably is in the range of 955 to 975 kg/m³, more preferably 960 to 972 kg/m³ and even more preferably 962 to 970 kg/m³.

It is further preferred that polyethylene component (A) consists of two fractions, i.e. a first ethylene polymer fraction (A-1) and a second ethylene polymer fraction (A-2), preferably a first ethylene homopolymer fraction (A-1) and a second ethylene homopolymer fraction (A-2).

It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably, fraction (A-1) is produced first.

The MFR₂ and/or the density of fractions (A-1) and (A-2) may be the same or may be different from each other.

Thus, the ethylene polymer fraction (A-1) preferably has a MFR₂ (190° C., 2.16 kg, ISO 1133) in the range of 5.0 to 100.0 g/10 min, preferably of 10.0 to 80.0 g/10 min, more preferably of 15.0 to 50.0 g/10 min and even more preferably of 20.0 to 40.0 g/10 min.

The ethylene polymer fraction (A-2) preferably has a MFR₂ (190° C., 2.16 kg, ISO 1133) in the range of 100.0 to 1500.0 g/10 min, preferably of 200.0 to 1200.0 g/10 min, more preferably of 300.0 to 1000.0 g/10 min and most preferably of 500.0 to 800.0 g/10 min.

Preferably, the MFR₂ of fraction (A-2) is higher than the MFR₂ of fraction (A-1).

The density of the ethylene polymer fraction (A-1) preferably is in the range of 945 to 970 kg/m³, more preferably 950 to 965 kg/m³ and even more preferably 952 to 962 kg/m³.

The ethylene polymer fraction (A-2) preferably has a density in the range of 960 to 980 kg/m³, more preferably 965 to 980 kg/m³ and even more preferably 970 to 978 kg/m³.

Preferably, the density of fraction (A-2) is higher than the density of fraction (A-1).

The polyethylene component (B) preferably has a MFR₂ in the range of 0.0005 to 0.8 g/10 min, more preferably 0.001 to 0.5 g/10 min, and even more preferably 0.002 to 0.1 g/10 min.

The density of the polyethylene component (B) preferably is in the range of 905 to 920 kg/m³, more preferably 908 to 918 kg/m³ and even more preferably 910 to 916 kg/m³.

The metallocene catalysed MDPE of embodiment (I) may be produced by polymerization using conditions which create a multimodal (e.g. bimodal) polymer product using a metallocene catalyst system.

Thus, the metallocene catalysed MDPE of embodiment (I) can be produced in a 2-stage process, preferably comprising a slurry reactor (loop reactor), whereby the slurry (loop) reactor is connected in series to a gas phase reactor (GPR), whereby either polyethylene component (A) or polyethylene component (B) is produced in the loop reactor and the other ethylene polymer component is then produced in GPR in the presence of the first produced ethylene polymer component to produce the metallocene catalysed MDPE, preferably the polyethylene component (A) is produced in the loop reactor and the polyethylene component (B) is produced in GPR in the presence of the polyethylene component (A) to produce the metallocene catalysed MDPE.

In case that the polyethylene component (A) of the metallocene catalysed MDPE consists of ethylene polymer fractions (A-1) and (A-2), the metallocene catalysed MDPE can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably fraction (A-1) is produced first.

Reaction conditions for the loop reactor(s) can be employed as described for embodiment (II) below.

The loop reactor 2 is thereby connected in series to a gas phase reactor (GPR), so that the polyethylene component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

The third polymerization stage is a gas phase polymerization step, i.e. carried out in a gas-phase reactor. Any suitable gas phase reactor known in the art may be used, such as a fluidised bed gas phase reactor.

For gas phase reactors, the reaction temperature used will generally be in the range 60 to 115° C. (e.g. 70 to 110° C.), the reactor pressure will generally be in the range 10 to 25 bar, and the residence time will generally be 1 to 8 hours. The gas used will commonly be a non-reactive gas such as nitrogen or low boiling point hydrocarbons such as propane together with monomer (e.g. ethylene).

A chain transfer agent (e.g. hydrogen) is typically added to the third polymerization stage.

Such a process is described inter alia in WO 2016/198273, WO 2021009189, WO 2021009190, WO 2021009191 and WO 2021009192. Full details of how to prepare suitable multimodal polymers can be found in these references.

A suitable process is the Borstar PE process or the Borstar PE 3G process.

The metallocene catalysed MDPE according to embodiment (I) of the present invention is therefore preferably produced in a loop loop gas cascade. Such polymerization steps may be preceded by a prepolymerization step.

The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry. Thus, the prepolymerization step may be conducted in a loop reactor.

The prepolymerization is then preferably conducted in an inert diluent, typically a hydrocarbon diluent such as methane, ethane, propane, n-butane, isobutane, pentanes, hexanes, heptanes, octanes etc., or their mixtures. Preferably, the diluent is a low-boiling hydrocarbon having from 1 to 4 carbon atoms or a mixture of such hydrocarbons.

The temperature in the prepolymerization step is typically from 0 to 90° C., preferably from 20 to 80° C. and more preferably from 45 to 75° C.

The pressure is not critical and is typically from 1 to 150 bar, preferably from 40 to 80 bar.

The amount of monomer is typically such that from 0.1 to 1000 grams of monomer per one gram of solid catalyst component is polymerized in the prepolymerization step. As the person skilled in the art knows, the catalyst particles recovered from a continuous prepolymerization reactor do not all contain the same amount of prepolymer. Instead, each particle has its own characteristic amount, which depends on the residence time of that particle in the prepolymerization reactor. As some particles remain in the reactor for a relatively long time and some for a relatively short time, then also the amount of prepolymer on different particles is different and some individual particles may contain an amount of prepolymer which is outside the above limits. However, the average amount of prepolymer on the catalyst typically is within the limits specified above.

The molecular weight of the prepolymer may be controlled by hydrogen as it is known in the art. Further, antistatic additives may be used to prevent the particles from adhering to each other or the walls of the reactor, as disclosed in WO-A-96/19503 and WO-A-96/32420.

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1.0 to 5.0 wt % in respect to the final metallocene catalysed MDPE. This can counted as part of the first polyethylene component (A).

### Catalyst

The metallocene catalysed MDPE of embodiment (I) of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

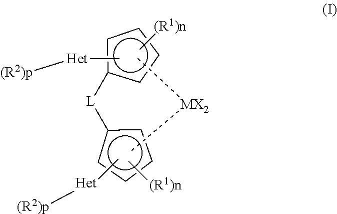

wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group; each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (I) has the structure

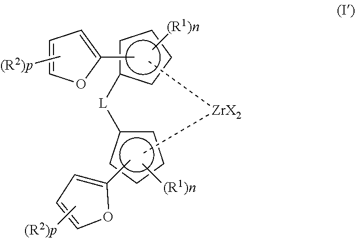

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (I) are

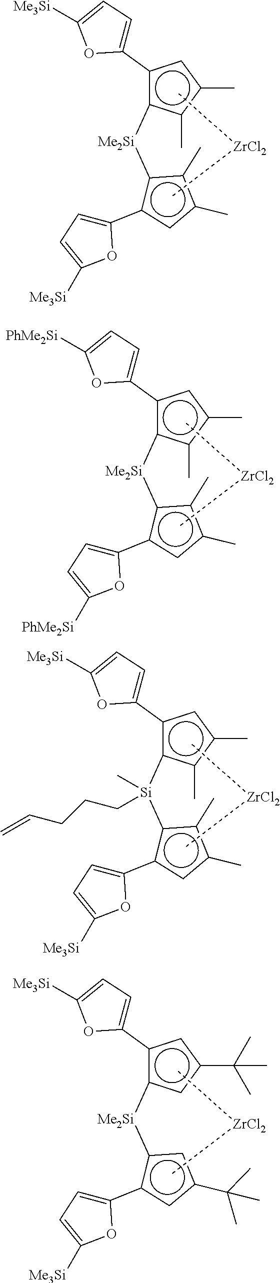

Most preferably the complex dimethylsilanediylbis[2-(5-trimethylsilylfuran-2-yl)-4,5-dimethylcyclopentadien-1-yl]zirconium dichloride is used.

More preferably the polyethylen components (A) and (B) of the metallocene catalysed MDPE are produced using, i.e. in the presence of, the same metallocene catalyst.

To form a catalyst, a cocatalyst, also known as an activator, is used, as is well known in the art. Cocatalysts comprising Δl or B are well known and can be used here. The use of aluminoxanes (e.g. MAO) or boron based cocatalysts (such as borates) is preferred.

Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used.

Ziegler Natta catalysts would not contain a Zr or Hf group (IV) metal for example.

### Embodiment (II)

The metallocene catalysed MDPE of embodiment (II) consists of
(i) 30 to 70 wt %, relative to the total weight of the MDPE, of a polyethylene component (X) with a density in the range of 920 to 950 kg/m³ and an MFR₂ (190° C., 2.16 kg, ISO 1133) of 0.01 to 2.0 g/10 min; and
(ii) 30 to 70 wt %, relative to the total weight of the MDPE, of a polyethylene component (Y) being a polyethylene with a density in the range of 920 to 960 kg/m³ and an MFR₂ (190° C., 2.16 kg, ISO 1133) of 0.1 to 10.0 g/10 min.

The weight ratio of polyethylene component (X) to polyethylene component (Y) in the metallocene catalysed MDPE in this embodiment (II) thus is in the range 30:70 to 70:30, preferably 35:65 to 65:35, more preferably 40:60 to 60:40. In some embodiments the ratio may be 35 to 50 wt % of polyethylene component (X) and 50 to 65 wt % of polyethylene component (Y), such as 40 to 50 wt % of component (X) and 50 to 60 wt % of component (Y), wherein the wt % values are relative to the total weight of the metallocene catalysed MDPE.

In a particularly preferred embodiment, the wt % values for polyethylene components (X) and (Y) add up to 100%.

In this embodiment (II) the polyethylene component (X) and/or (Y) can be a homopolymer or an ethylene copolymer, preferably both components are an ethylene copolymer.

Preferably, component (X) as well as component (Y) consist of a single ethylene copolymer.

Preferred ethylene copolymers employ alpha-olefins (e.g. C3-12 alpha-olefins) as comonomers. Examples of suitable alpha-olefins include 1-butene, 1-hexene and 1-octene. 1-butene is an especially preferred comonomer.

More preferably, both polyethylene components (X) and (Y) are an ethylene-1-butene copolymer.

The polyethylene component (X) preferably has a MFR₂ in the range of 0.05 to 1.5 g/10 min, more preferably 0.1 to 1.0 g/10 min, and even more preferably 0.2 to 0.8 g/10 min.

The density of polyethylene component (X) preferably is in the range of 925 to 945 kg/m³, more preferably 928 to 942 kg/m³ and even more preferably 930 to 940 kg/m³.

The polyethylene component (Y) preferably has a MFR₂ in the range of 0.5 to 6.0 g/10 min, more preferably 0.8 to 4.0 g/10 min, and even more preferably 1.0 to 2.5 g/10 min.

The density of the polyethylene component (B) preferably is in the range of 930 to 955 kg/m³, more preferably 935 to 950 kg/m³ and even more preferably 938 to 945 kg/m³.

The metallocene catalysed MDPE of embodiment (II) may be produced by polymerization using conditions which create a multimodal (e.g. bimodal) polymer product using a metallocene catalyst system, e.g. the metallocene catalyst system as described for embodiment (I).

Thus, the metallocene catalysed MDPE of embodiment (II) can be produced in a 2-stage process, preferably comprising a slurry reactor (loop reactor 1), whereby the slurry (loop 1) reactor is connected in series to a further slurry reactor (loop reactor 2), whereby either polyethylene component (X) or polyethylene component (Y) is produced in the loop reactor 1 and the other ethylene polymer component is then produced in the loop reactor 2 in the presence of the first produced ethylene polymer component to produce the metallocene catalysed MDPE, preferably the polyethylene component (X) is produced in the loop reactor 1 and the polyethylene component (Y) is produced in loop rector 2 in the presence of the polyethylene component (X) to produce the metallocene catalysed MDPE.

The first polymerization stage produces polyethylene component (X), which is subsequently fed to the second polymerization stage. The second polymerization stage produces polyethylene component (Y), thus generating the metallocene catalysed MDPE of embodiment (II).

The first and the second polymerization stages are preferably slurry polymerization steps.

The slurry polymerization usually takes place in an inert diluent, typically a hydrocarbon diluent such as methane, ethane, propane, n-butane, isobutane, pentanes, hexanes, heptanes, octanes etc., or their mixtures. Preferably, the diluent is a low-boiling hydrocarbon having from 1 to 4 carbon atoms or a mixture of such hydrocarbons. An especially preferred diluent is propane, possibly containing minor amount of methane, ethane and/or butane.

The temperature in each of the first and second polymerization stages is typically from 60 to 100° C., preferably from 70 to 90° C. An excessively high temperature should be avoided to prevent partial dissolution of the polymer into the diluent and the fouling of the reactor. The pressure is from 1 to 150 bar, preferably from 40 to 80 bar.

The slurry polymerization may be conducted in any known reactor used for slurry polymerization. Such reactors include a continuous stirred tank reactor and a loop reactor. It is especially preferred to conduct the slurry polymerization in a loop reactor. In such reactors the slurry is circulated with a high velocity along a closed pipe by using a circulation pump.

Loop reactors are generally known in the art and examples are given, for instance, in U.S. Pat. Nos. 4,582,816, 3,405,109, 3,324,093, EP-A-479186 and U.S. Pat. No. 5,391,654. It is thus preferred to conduct the first and second polymerization stages as slurry polymerizations in two consecutive loop reactors.

The slurry may be withdrawn from each reactor either continuously or intermittently. A preferred way of intermittent withdrawal is the use of settling legs where slurry is allowed to concentrate before withdrawing a batch of the concentrated slurry from the reactor. The use of settling legs is disclosed, among others, in U.S. Pat. Nos. 3,374,211, 3,242,150 and EP-A-1310295. Continuous withdrawal is disclosed, among others, in EP-A-891990, EP-A-1415999, EP-A-1591460 and WO-A-2007/025640. The continuous withdrawal is advantageously combined with a suitable concentration method, as disclosed in EP-A-1310295 and EP-A-1591460. It is preferred to withdraw the slurry from each of the first and second polymerization stages continuously.

Hydrogen is typically introduced into the first and second polymerization stages for controlling the MFR2 of the first and second ethylene polymers. The amount of hydrogen needed to reach the desired MFR depends on the catalyst used and the polymerization conditions.

The production rate is suitably controlled with the catalyst feed rate. It is also possible to influence the production rate by suitable selection of the monomer concentration. The desired monomer concentration can then be achieved by suitably adjusting the ethylene feed rate.

The metallocene catalysed MDPE according to embodiment (II) of the present invention is therefore preferably produced in a loop loop cascade. Such polymerization steps may be preceded by a prepolymerization step as described above for embodiment (I).

### (II) Mixed-Plastic-Polyethylene Recycling Blend (PERB)

In addition to the the metallocene catalysed MDPE, the composition of the present invention comprises a mixed-plastic-polyethylene recycling blend (PERB).

It is the essence of the present invention that this recycling blend is obtained from a post-consumer waste stream and/or a post-industrial waste stream, preferably from a post-consumer waste stream.

According to the present invention the mixed-plastic-polyethylene recycling blend (PERB) is generally a blend, wherein at least 90 wt %, preferably at least 95 wt %, more preferably 100 wt % of the mixed-plastic-polyethylene recycling blend (PERB) originates from post-consumer waste, such as from conventional collecting systems (curb-side collection), such as those implemented in the European Union, and/or post-industrial waste, preferably from post-consumer waste.

Said post-consumer waste may be identified by its limonene content. It is preferred that the post-consumer waste has a limonene content of from 0.1 to 500 mg/kg.

The mixed-plastic-polyethylene recycling blend (PERB) preferably comprises a total amount of ethylene units (C2 units) of from 80.0 wt % to 96.0 wt %, more preferably of from 82.5 wt % to 95.5 wt %, still more preferably of from 85.0 wt % to 95.5 wt % and most preferably of from 87.5 wt % to 95.0 wt %;
a total amount of continuous units having 3 carbon atoms corresponding to polypropylene (continuous C3 units) of from 0.2 to 6.5 wt %, more preferably from 0.4 wt % to 6.0 wt %, still more preferably from 0.6 wt % to 5.5 wt % and most preferably from 0.75 wt % to 5.0 wt %.

The total amounts of C2 units and continuous C3 units thereby are based on the total weight amount of monomer units in the mixed-plastic-polyethylene recycling blend (PERB) and are measured according to quantitative ¹³C{1H} NMR measurement.

In addition to C2 units and continuous C3 units the mixed-plastic-polyethylene recycling blend (B) can further comprise units having 3, 4, 6 or 7 or more carbon atoms so that the mixed-plastic-polyethylene recycling blend (B) overall can comprise ethylene units and a mix of units having 3, 4, 6 and 7 or more carbon atoms.

The mixed-plastic-polyethylene recycling blend (PERB) preferably comprises one or more in any combination, preferably all of:
a total amount of units having 3 carbon atoms as isolated C3 units (isolated C3 units) of from 0.00 wt % to 0.50 wt %, more preferably from 0.00 wt % to 0.40 wt %, still more preferably from 0.00 wt % to 0.30 wt % and most preferably from 0.00 wt % to 0.25 wt %;
a total amount of units having 4 carbon atoms (C4 units) of from 0.50 to 5.00 wt %, more preferably from 0.75 wt % to 4.00 wt %, still more preferably from 1.00 wt % to 3.50 wt % and most preferably from 1.25 wt % to 3.00 wt %;
a total amount of units having 6 carbon atoms (C6 units) of from 0.50 to 7.50 wt %, more preferably from 0.75 wt % to 6.50 wt %, still more preferably from 1.00 wt % to 5.50 wt % and most preferably from 1.25 wt % to 5.00 wt %;
a total amount of units having 7 carbon atoms (C7 units) of from 0.20 wt % to 2.50 wt %, of from 0.30 wt % to 2.00 wt %, still more preferably of from 0.40 to 1.50 wt % and most preferably of from 0.45 wt % to 1.25 wt %, and
a LDPE content of from 20.0 to 65.0 wt %, more preferably from 25.0 wt % to 62.5 wt %, still more preferably from 30.0 wt % to 60.0 wt % and most preferably from 32.0 wt % to 55.0 wt %.

The total amounts of C2 units, continuous C3 units, isolated C3 units, C4 units, C6 units, C7 units and LDPE content thereby are based on the total weight amount of monomer units in the mixed-plastic-polyethylene recycling blend (B) and are measured or calculated according to quantitative ¹³C{1H} NMR measurement.

Preferably, the total amount of units, which can be attributed to comonomers (i.e. isolated C3 units, C4 units and C6 units), in the mixed-plastic-polyethylene recycling blend (PERB) is from 4.00 wt % to 20.00 wt %, more preferably from 4.50 wt % to 17.50 wt %, still more preferably from 4.75 wt % to 15.00 wt % and most preferably from 5.00 wt % to 12.50 wt %, and is measured according to quantitative ¹³C{1H} NMR measurement.

It is preferred that the mixed-plastic-polyethylene recycling blend (PERB) has
a MFR₂ (ISO 1133, 2.16 kg, 190° C.) of from 0.1 to 1.2 g/10 min, more preferably from 0.3 to 1.1 g/10 min; and/or
a density of from 910 to 945 kg/m³, more preferably from 915 to 942 kg/m³, most preferably from 918 to 940 kg/m³.

The mixed-plastic-polyethylene recycling blend (PERB) preferably does not comprise carbon black. It is further preferred that the mixed-plastic-polyethylene recycling blend (PERB) does not comprise any pigments other than carbon black.

The mixed-plastic-polyethylene recycling blend (PERB) preferably is a natural mixed-plastic-polyethylene recycling blend (PERB).

The mixed-plastic-polyethylene recycling blend (PERB) may also include:
0 to 10 wt % units derived from alpha olefin(s),
0 to 3.0 wt % stabilizers,
0 to 3.0 wt % talc,
0 to 3.0 wt % chalk,
0 to 6.0 wt % further components
all percentages with respect to the mixed-plastic-polyethylene recycling blend (PERB).

The mixed-plastic-polyethylene recycling blend (PERB) preferably has one or more, more preferably all, of the following properties in any combination:
a MFR₅ (ISO 1133, 5.0 kg, 190° C.) of from 1.5 to 5.0 g/10 min, more preferably from 2.0 to 4.0 g/10 min;
a MFR₂₁ (ISO 1133, 21.6 kg, 190° C.) of from 20.0 to 50.0 g/10 min, more preferably from 25.0 to 45.0 g/10 min;
a polydispersity index PI of from 1.0 to 3.5 s⁻¹, more preferably from 1.3 to 3.0 s⁻¹;
a shear thinning index SHI_{2.7/210} of from 15 to 40, more preferably from 20 to 35;
a complex viscosity at the frequency of 300 rad/s, eta300, of from 500 to 750 Pa-s, more preferably from 550 to 700 Pa·s;
a complex viscosity at the frequency of 0.05 rad/s, eta0.05, of from 15000 to 30000 Pa-s, more preferably from 15500 to 27500 Pa·s;
a strain hardening modulus, SH modulus, of from 12.5 to 20.0 MPa, more preferably from 13.0 to 17.5 MPa.

It is preferred that the mixed-plastic-polyethylene recycling blend (PERB) has a comparatively low gel content, especially in comparison to other mixed-plastic-polyethylene recycling blends.

The mixed-plastic-polyethylene recycling blend (PERB) preferably has a gel content for gels with a size of from above 600 μm to 1000 μm of not more than 1000 gels/m², more preferably not more than 850 gels/m². The lower limit of the gel content for gels with a size of from above 600 μm to 1000 μm is usually 100 gels/m², preferably 150 gels/m².

Still further, the mixed-plastic-polyethylene recycling blend (PERB) preferably has a gel content for gels with a size of from above 1000 μm of not more than 200 gels/m², more preferably not more than 150 gels/m². The lower limit of the gel content for gels with a size of from above 1000 μm is usually 10 gels/m², preferably 14 gels/m².

Mixed-plastic-polyethylene blend(s) (PERB) as used herein are commercially available. One suitable recyclate is e.g. available from Ecoplast Kunststoffrecycling GmbH under the brand names NAV 101 and NAV 102.

As mentioned above, the polyethylene composition according to the present invention provides an improved balance between stiffness, impact and optics, i.e. haze, to films comprising the blend.

The specific design of the metallocene catalysed MDPE (MDPE) thereby allows the addition of more recyclate, i.e. of more than 50 wt % of the composition, and still provides films with good impact/stiffness/optics balance.

The invention is therefore further directed to a film comprising at least one layer comprising the above described composition.

### Film

The film of the invention comprises at least one layer comprising the above defined polyethylene composition. The film can be a monolayer film comprising the above defined polyethylene composition or a multilayer film, wherein at least one layer comprises the above defined polyethylene composition. The terms “monolayer film” and multilayer film” have well known meanings in the art.

The films are preferably produced by any conventional film extrusion procedure known in the art including cast film and blown film extrusion. Most preferably, the film is a blown or cast film, especially a blown film. E.g. the blown film is produced by extrusion through an annular die and blowing into a tubular film by forming a bubble which is collapsed between nip rollers after solidification. This film can then be slit, cut or converted (e.g. gusseted) as desired.

Conventional film production techniques may be used in this regard. If the preferable blown or cast film is a multilayer film then the various layers are typically coextruded. The skilled man will be aware of suitable extrusion conditions.

Films according to the present invention may be subjected to post-treatment processes, e.g. surface modifications, lamination or orientation processes or the like. Such orientation processes can be mono-axially (MDO) or bi-axially orientation, wherein mono-axial orientation is preferred.

In another preferred embodiment, the films are unoriented.

Preferred films according to the invention are monolayer blown films.

The monolayer film of the invention may have a thickness of 20 to 120 μm, preferably 30 to 100 μm and more preferably 35 to 80 μm.

The films preferably comprise at least 90 wt %, more preferably at least 95 wt %, even more preferably at least 99 wt % and still more preferably consists of the composition according to the present invention.

The films according to the present invention have at least one or more or all of the below described properties a) to c):
a) the films of the invention have a dart-drop impact strength (DDI) determined according to ISO 7765-1:1988 on a 40 μm monolayer test blown film of at least 60 g up to 250 g, preferably 65 g up to 200 g and more preferably 70 g up to 150 g, and/or
b) films according to the present invention may further have a haze measured according to ASTM D1003 on a 40 μm test blown film of below 22.0%, preferably in the range of 5.0 to 21.0%, more preferably 10.0 to 20.0% and even more preferably 12.0 to 17.0%, and/or
c) films according to the present invention have good stiffness (tensile modulus measured on a 40 μm monolayer test blown film according to ISO 527-3), i.e. >150 MPa (in both directions).

Thus, the films comprising the polyethylene composition have a tensile modulus (measured on a 40 μm monolayer test blown film according to ISO 527-3) in machine (MD) as well as in transverse (TD) direction in the range of from >150 MPa to 500 MPa, preferably of from 200 MPa to 400 MPa.
d) In one embodiment of the present invention, the optomechanical ability (OMA) according to formula (II):

$$OMA = \frac{Tensile Modulus ( MD ) [ MPa ] * DDI ( g )}{Haze ( 40 μm ) [ \% ]}$$

determined on 40 μm test blown film is at least 1150 [MPa*g/%] up to 3000 [MPa*g/%], preferably in the range of from 1200 [MPa*g/%] up to 2500 [MPa*g/%], more preferably in the range of from 1300 [MPa*g/%] up to 2000 [MPa*g/%], wherein the Tensile Modulus in machine direction is measured according to ISO 527-3 at 23° C. on 40 μm test blown films, DDI is the dart-drop impact strength determined according to ISO 7765-1:1988 on a 40 μm test blown film and haze is measured according to ASTM D1003 on a 40 μm test blown film.

Preferably, films according to the present invention fulfil parameters d) and additionally at least parameter a) more preferably parameters d) and additionally parameter a) and b).

The films according to the present invention are highly useful for being used in various packaging applications, in particular for secondary packaging, which do not require a food approval or even for primary packaging for non-food products.

Furthermore the films according to the present invention may be used as a layer in multilayer polyethylene based blown films, preferably as core layer in multilayer polyethylene based blown films.

The invention will be further described with reference to the following non-limiting examples.

### Determination Methods

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min.

The MFR is an indication of the flowability, and hence the processability, of the polymer. The MFR is determined at 190° C. for polyethylene. MFR may be determined at different loadings such as 2.16 kg (MFR₂), 5 kg (MFR₅) or 21.6 kg (MFR₂₁).

### Calculation of MFR₂ of Component B and of Fraction (A-2)

$$log A = x \cdot log B + ( 1 - x ) \cdot log C$$

$$C = 10 {\hat{}}^{\frac{( logA - x \cdot logB )}{( 1 - x )}}$$

For Component B:

$$B = {MFR}_{2} of Component ( A )$$

$$C = {MFR}_{2} of Component ( B )$$

$$A = final {MFR}_{2} ( mixture ) of multimodal polyethylene copolymer ( P )$$

$$X = weight fraction of Component ( A ) .$$

For Fraction (A-2):

$$B = {MFR}_{2} of {1}^{st} fraction ( A - 1 )$$

$$C = {MFR}_{2} of {2}^{nd} fraction ( A - 2 )$$

$$A = final {MFR}_{2} ( mixture ) of loop polymer ( = Component ( A ) )$$

$$X = weight fraction of the {1}^{st} fraction ( A - 1 ) .$$

### Density

Density of the polymer was measured according to ISO 1183 and ISO1872-2 for sample preparation and is given in kg/m³.

### GPC

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain), equipped with 3 x Agilent-PLgel Olexis and 1× Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol.

The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL / g , {α}_{PS} = 0.655$$

$${K}_{PE} = 39 \times {10}^{- 3} mL / g , {α}_{PE} = 0.725$$

$${K}_{PP} = 19 \times {10}^{- 3} mL / g , {α}_{PP} = 0.725$$

A third order polynomial fit was used to fit the calibration data.

All samples were prepared in the concentration range of 0.5-1 mg/ml and dissolved at 160° C. for 2.5 hours for PP or 3 hours for PE under continuous gentle shaking.

### Dart Drop Strength (DDI): Impact Resistance by Free-Falling Dart Method

The DDI was measured according to ISO 7765-1:1988/Method A from the films (non-oriented films and laminates) as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

Standard conditions:

$$Conditioning time : > 96 h$$

Test temperature: 23° C.
Dart head material: phenolic
Dart diameter: 38 mm
Drop height: 660 mm

Results:

$$Impact failure weight - 50 \% [ g ]$$

### Tensile Modulus

Tensile modulus (E-Mod (MPa) was measured in machine and/or transverse direction according to ISO 527-3 on film samples prepared as described under the Film Sample preparation with film thickness of 40 μm and at a cross head speed of 1 mm/min for the modulus.

### Haze

Haze was determined according to ASTM D 1003-00 on films as produced indicated below.

Optomechanical ability (OMA) was determined on 40 μm test blown film and was calculated according to formula (II):

$$OMA = \frac{Tensile Modulus ( MD ) [ MPa ] * DDI ( g )}{Haze ( 40 μm ) [ \% ]}$$

wherein the Tensile Modulus in machine direction was measured according to ISO 527-3 at 23° C., DDI is the dart-drop impact strength determined according to ISO 7765-1:1988 and haze was measured according to ASTM D1003.

### Quantification of C2, iPP (Continuous C3), LDPE and Polyethylene Short Chain Branches in Polyethylene Based Recyclates

Quantitative ¹³C{¹H} NMR spectra were recorded in the solution-state using a Bruker Avancelll 400 MHz NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 m¹ of 1,2-tetrachloroethane-d₂ (TCE-d₂) along with chromium-(III)-acetylacetonate (Cr(acac)₃) resulting in a 65 mM solution of relaxation agent in solvent {singh09}. To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {zhou07, busico07}. A total of 6144 (6k) transients were acquired per spectra.

Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. Characteristic signals corresponding to polyethylene with different short chain branches (B1, B2, B4, B5, B6plus) and polypropylene were observed {randall89, brandolini00}.

Characteristic signals corresponding to the presence of polyethylene containing isolated B1 branches (starB1 33.3 ppm), isolated B2 branches (starB2 39.8 ppm), isolated B4 branches (twoB4 23.4 ppm), isolated B5 branches (threeB5 32.8 ppm), all branches longer than 4 carbons (starB4plus 38.3 ppm) and the third carbon from a saturated aliphatic chain end (3s 32.2 ppm) were observed. The intensity of the combined ethylene backbone methine carbons (ddg) containing the polyethylene backbone carbons (dd 30.0 ppm), γ-carbons (g 29.6 ppm) the 4s and the threeB4 carbon (to be compensated for later on) is taken between 30.9 ppm and 29.3 ppm excluding the Tpp from polypropylene. The amount of C2 related carbons was quantified using all mentioned signals according to the following equation:

$${fC}_{C 2 total} = ( Iddg - ItwoB 4 ) + ( IstarB {1}^{*} 6 ) + ( IstarB {2}^{*} 7 ) + ( ItwoB {4}^{*} 9 ) + I ( threeB {5}^{*} 10 ) + ( {( IstarB 4 plus - ItwoB 4 - IthreeB 5 )}^{*} 7 ) + ( I 3 {s}^{*} 3 )$$

Characteristic signals corresponding to the presence of polypropylene (iPP, continuous C3)) were observed at 46.7 ppm, 29.0 ppm and 22.0 ppm. The amount of PP related carbons was quantified using the integral of Sαα at 46.6 ppm:

$${fC}_{P P} = Is αα * 3$$

The weight percent of the C2 fraction and the polypropylene can be quantified according following equations:

$$w {t}_{C 2 fraction} = {fC}_{C 2 total} * 100 / ( {fC}_{C 2 total} + {fC}_{P P} )$$

$$w {t}_{P P} = {fC}_{PP} * 100 / ( {fC}_{C 2 total} + {fC}_{P P} )$$

Characteristic signals corresponding to various short chain branches were observed and their weight percentages quantified as the related branch would be an alpha-olefin, starting by quantifying the weight fraction of each:

$$fwtC 2 = {fC}_{C 2 total} - ( ( IstarB 1 * 3 ) - ( IstarB 2 * 4 ) - ( ItwoB 4 * 6 ) - ( IthreeB 5 * 7 )$$

$$fwtC 3 ( isolated C 3 ) = IstarB 1 * 3$$

$$fwtC 4 = IstarB 2 * 4$$

$$fwtC 6 = ItwoB 4 * 6$$

$$fwtC 7 = IthreeB 5 * 7$$

Normalisation of all weight fractions leads to the amount of weight percent for all related branches:

$$fsu {m}_{wt \% total} = fwtC 2 + fwtC 3 + fwtC 4 + fwtC 6 + fwtC 7 + {fC}_{P P}$$

$$wtC 2 total = fwtC 2 * 100 / {fsum}_{wt \% total}$$

$$wtC 3 total = fwtC 3 * 100 / {fsum}_{wt \% total}$$

$$wtC 4 total = fwtC 4 * 100 / {fsum}_{wt \% total}$$

$$wtC 6 total = fwtC 6 * 100 / {fsum}_{wt \% total}$$

$$wtC 7 total = fwtC 7 * 100 / {fsum}_{wt \% total}$$

The content of LDPE can be estimated assuming the B5 branch, which only arises from ethylene being polymerized under high pressure process, being almost constant in LDPE. We found the average amount of B5 if quantified as C7 at 1.46 wt %. With this assumption it is possible to estimate the LDPE content within certain ranges (approximately between 20 wt % and 80 wt %), which are depending on the SNR ratio of the threeB5 signal:

$$wt \% LDPE = wtC 7 total * 100 / 1.46$$

### REFERENCES

zhou07 Zhou, Z., Kuemmerle, R., Qiu, X., Redwine, D., Cong, R., Taha, A., Baugh, D. Winniford, B., J. Mag. Reson. 187 (2007) 225.
busico07 Busico, V., Carbonniere, P., Cipullo, R., Pellecchia, R., Severn, J., Talarico, G., Macromol. Rapid Commun. 2007, 28, 1128.
singh09 Singh, G., Kothari, A., Gupta, V., Polymer Testing 28 5 (2009), 475.
randall89 J. Randall, Macromol. Sci., Rev. Macromol. Chem. Phys. 1989, C29, 201.
brandolini00 A. J. Brandolini, D. D. Hills, NMR Spectra of Polymers and Polymer Additives, Marcel Dekker Inc., 2000.

### Rheological Measurements

### Dynamic Shear Measurements (Frequency Sweep Measurements)

The characterisation of melt of polymer composition or polymer as given above or below in the context by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where
σ₀ and γ₀ are the stress and strain amplitudes, respectively
ω is the angular frequency
δ is the phase shift (loss angle between applied strain and stress response)
t is the time

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan 6 which can be expressed as follows:

$${G}^{′} = \frac{{σ}_{0}}{{γ}_{0}} cos δ [ Pa ] \qquad ( 3 )$$

$${G}^{″} = \frac{{σ}_{0}}{{γ}_{0}} sin δ [ Pa ] \qquad ( 4 )$$

$${G}^{*} = {G}^{′} + {iG}^{″} [ Pa ] \qquad ( 5 )$$

$${η}^{*} = {η}^{′} - i {η}^{″} [ Pa . s ] \qquad ( 6 )$$

$${η}^{′} = \frac{{G}^{″}}{ω} [ Pa . s ] \qquad ( 7 )$$

$${η}^{″} = \frac{{G}^{′}}{ω} [ Pa . s ] \qquad ( 8 )$$

The determination of so-called Shear Thinning Index, which correlates with MWD and is independent of Mw, is done as described in equation 9.

$${SHI}_{( x / y )} = \frac{{Eta}^{*} for ( {G}^{*} = x kPa )}{{Eta}^{*} for ( {G}^{*} = y kPa )} \qquad ( 9 )$$

For example, the SHI_{(2.7/210)} is defined by the value of the complex viscosity, in Pa s, determined for a value of G* equal to 2.7 kPa, divided by the value of the complex viscosity, in Pa s, determined for a value of G* equal to 210 kPa.

The values of storage modulus (G′), loss modulus (G″), complex modulus (G*) and complex viscosity (η*) were obtained as a function of frequency (ω).

Thereby, e.g. η*_{300rad/s} (eta*_{300rad/s}) is used as abbreviation for the complex viscosity at the frequency of 300 rad/s and η*_{0.05rad/s} (eta*_{0.05rad/s}) is used as abbreviation for the complex viscosity at the frequency of 0.05 rad/s.

The loss tangent tan (delta) is defined as the ratio of the loss modulus (G″) and the storage modulus (G′) at a given frequency. Thereby, e.g. tan_{0.05} is used as abbreviation for the ratio of the loss modulus (G″) and the storage modulus (G′) at 0.05 rad/s and tan₃₀₀ is used as abbreviation for the ratio of the loss modulus (G″) and the storage modulus (G′) at 300 rad/s.

The elasticity balance tan_{0.05}/tan₃₀₀ is defined as the ratio of the loss tangent tan_{0.05} and the loss tangent tan₃₀₀.

Besides the above mentioned rheological functions one can also determine other rheological parameters such as the so-called elasticity index EI(x). The elasticity index EI(x) is the value of the storage modulus (G′) determined for a value of the loss modulus (G″) of x kPa and can be described by equation 10.

$$EI ( x ) = {G}^{′} for ( {G}^{″} = x kPa ) [ Pa ] \qquad ( 10 )$$

For example, the EI(5 kPa) is the defined by the value of the storage modulus (G′), determined for a value of G″ equal to 5 kPa.

The polydispersity index, PI, is defined by equation 11.

$$PI = \frac{1 {0}^{5}}{{G}^{′} ( {ω}_{C O P} )} , {ω}_{COP} = ω for ( {G}^{′} = {G}^{″} ) \qquad ( 11 )$$

where ω_{COP} is the cross-over angular frequency, determined as the angular frequency for which the storage modulus, G′, equals the loss modulus, G″.

The values are determined by means of a single point interpolation procedure, as defined by Rheoplus software. In situations for which a given G* value is not experimentally reached, the value is determined by means of an extrapolation, using the same procedure as before.

In both cases (interpolation or extrapolation), the option from Rheoplus “Interpolate y-values to x-values from parameter” and the “logarithmic interpolation type” were applied.

### REFERENCES

[1] Rheological characterization of polyethylene fractions” Heino, E. L., Lehtinen, A., Tanner J., Seppsls, J., Neste Oy, Porvoo, Finland, Theor. Appl. Rheol., Proc. Int. Congr. Rheol, 11th (1992), 1, 360-362.
[2] The influence of molecular structure on some rheological properties of polyethylene”, Heino, E. L., Borealis Polymers Oy, Porvoo, Finland, Annual Transactions of the Nordic Rheology Society, 1995.).
[3] Definition of terms relating to the non-ultimate mechanical properties of polymers, Pure & Appl. Chem., Vol. 70, No. 3, pp. 701-754, 1998.

### Strain Hardening (SH) Modulus

The strain hardening test is a modified tensile test performed at 80° C. on a specially prepared thin sample. The Strain Hardening Modulus (MPa), <Gp>, is calculated from True Strain-True Stress curves; by using the slope of the curve in the region of True Strain, λ, is between 8 and 12.

The true strain, λ, is calculated from the length, l (mm), and the gauge length, l0 (mm), as shown by Equation 1.

$$λ = \frac{I}{{I}_{0}} = 1 + \frac{Δ I}{{I}_{0}} \qquad ( 1 )$$

where Δl is the increase in the specimen length between the gauge marks, (mm). The true stress, σtrue (MPa), is calculated according to formula 2, assuming conservation of volume between the gauge marks:

$${σ}_{t r u e} = {σ}_{n} λ \qquad ( 2 )$$

where σn is the engineering stress.

The Neo-Hookean constitutive model (Equation 3) is used to fit the true strain- true stress data from which <Gp> (MPa) for 8<λ<12 is calculated.

$${σ}_{t r u e} = \frac{< Gp >}{20} ( {λ}^{2} - \frac{1}{λ} ) + C \qquad ( 3 )$$

where C is a mathematical parameter of the constitutive model describing the yield stress extrapolated to λ=0.

Initially five specimens are measured. If the variation coefficient of <Gp> is greater than 2.5%, then two extra specimens are measured. In case straining of the test bar takes place in the clamps the test result is discarded.

The PE granules of materials were compression molded in sheets of 0.30 mm thickness according to the press parameters as provided in ISO 17855-2.

After compression molding of the sheets, the sheets were annealed to remove any orientation or thermal history and maintain isotropic sheets. Annealing of the sheets was performed for 1 h in an oven at a temperature of (120±2) ° C. followed by slowly cooling down to room temperature by switching off the temperature chamber. During this operation free movement of the sheets was allowed.

Next, the test pieces were punched from the pressed sheets. The specimen geometry of the modified ISO 37:1994 Type 3 (FIG. 3 in ISO 37:1994) was used.

The sample has a large clamping area to prevent grip slip, dimensions given in Table A.

TABLE A
Dimensions of Modified ISO 37: 1994 Type 3

| Dimension | | Size (mm) |
|---|---|---|
| L | start length between clamps | 30.0 +/− 0.5 |
| I0 | Gauge length | 12.5 +/− 0.1 |
| I1 | Prismatic length | 16.0 +/− 1.0 |
| I3 | Total length | 70 |
| R1 | Radius | 10.0 +/− 0.03 |
| R2 | Radius | 8.06 +/− 0.03 |
| b1 | Prismatic width | 4.0 +/− 0.01 |
| b2 | Clamp width | 20.0 +/− 1.0 |
| h | Thickness | 0.30 + 0.05/0.30 − 0.03 |

The punching procedure is carried out in such a way that no deformation, crazes or other irregularities are present in the test pieces.

The thickness of the samples was measured at three points of the parallel area of the specimen; the lowest measured value of the thickness of these measurements was used for data treatment.
1. The following procedure is performed on a universal tensile testing machine having controlled temperature chamber and non-contact extensometer: 2. Condition the test specimens for at least 30 min in the temperature chamber at a temperature of (80±1) ° C. prior to starting the test.
3. Clamp the test piece on the upper side.
4. Close the temperature chamber.
5. Close the lower clamp after reaching the temperature of (80±1) ° C.
6. Equilibrate the sample for 1 min between the clamps, before the load is applied and measurement starts.
7. Add a pre-load of 0.5 N at a speed of 5 mm/min.
8. Extend the test specimen along its major axis at a constant traverse speed (20 mm/min) until the sample breaks.

During the test, the load sustained by the specimen is measured with a load cell of 200 N. The elongation is measured with a non-contact extensometer.

### Gel Content

The gel count was measured with a gel counting apparatus consisting of a measuring extruder, ME 25/5200 V1, 25*25D, with five temperature conditioning zones adjusted to a temperature profile of 170/180/190/190/190° C.), an adapter and a slit die (with an opening of 0.5*150 mm). Attached to this were a chill roll unit (with a diameter of 13 cm with a temperature set of 50° C.), a line camera (CCD 4096 pixel for dynamic digital processing of grey tone images) and a winding unit.

For the gel count content measurements the materials were extruded at a screw speed of 30 rounds per minute, a drawing speed of 3-3.5 m/min and a chill roll temperature of 50° C. to make thin cast films with a thickness of 70 μm and a width of approximately 110 mm.

The resolution of the camera is 25 μm×25 μm on the film. The camera works in transmission mode with a constant grey value (auto.set. margin level=170). The system is able to decide between 256 grey values from black=0 to white=256. For detecting gels, a sensitivity level dark of 25% is used. For each material the average number of gel dots on a film surface area of 10 m² was inspected by the line camera. The line camera was set to differentiate the gel dot size according to the following:
Gel size (the size of the longest dimension of a gel)
300 μm to 599 μm
600 μm to 999 μm
above 1000 μm

### Film Sample Preparation

The test films consisting of the inventive compositions and respective comparative compositions of 40 μm thickness, were prepared using a Collin 30 lab scale mono layer blown film line. The film samples were produced at 194° C., a 1:2.5 blow-up ratio, frostline distance of 120 mm.

Blending was done directly on the film extrusion line.

### EXAMPLES

Materials used:

As mixed-plastic-polyethylene recycling blend (PERB) NAV 101 was used.

NAV 101 is a low density polyethylene (LDPE) post-consumer recyclate blend available from Ecoplast Kunststoffrecycling GmbH. The properties of NAV101 are shown in table B.

TABLE B
Properties of NAV 101

| | |
|---|---|
| Ethylene content (wt %) | 90.67 |
| isol. C3 content (wt %) | 0 |
| C4 content (wt %) | 2.23 |
| C6 content (wt %) | 2.73 |
| C7 content (wt %) | 0.48 |
| iPP content (wt %) | 3.89 |
| LDPE content (wt %) | 33.00 |
| Density (kg/m³) | 923.9 |
| MFR₂ (g/10 min) | 1.02 |
| MFR₅ (g/10 min) | 3.57 |
| MFR₂₁ (g/10 min) | 41.56 |
| SHI2.7/210 | 22.16 |
| eta0.05 (Pa · s) | 16187 |
| eta300 (Pa · s) | 618 |
| PI (s − 1) | 1.46 |
| SH modulus (MPa) | 14.3 |
| Gel content (>1000 μm) (1/m²) | 16.9 |
| Gel content (600-1000 μm) (1/m²) | 175.1 |
| Gel content (300-599) (μm/1 m²) | 885.9 |

### Blending Partner for Comparative Examples CE2

Lumicene Supertough 40ST05 (40ST05), commercially available from Total, a metallocene MDPE with density 940 kg/m³, MFR₂ 0.5 g/10 min.

### Cat.Example: Catalyst Preparation for CAT1 for Inventive Examples IE1 and IE2, and Comparative Example CE1

Loading of SiO2:

10 kg of silica (PQ Corporation ES757, calcined 600° C.) was added from a feeding drum and inertized in the reactor until 02 level below 2 ppm was reached.

### Preparation of MAO/tol/MC

30 wt % MAO in toluene (14.1 kg) was added into another reactor from a balance followed by toluene (4.0 kg) at 25° C. (oil circulation temp) and stirring 95 rpm. Stirring speed was increased 95 rpm→200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst

Reactor temperature was set to 10° C. (oil circulation temp) and stirring was turned to 40 rpm during MAO/tol/MC addition. MAO/tol/MC solution (22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

Polymerization:
IE1: Borstar pilot plant with a 3-reactor set-up (loop1-loop2-GPR 1) and a prepolymerization loop reactor. (MDPE-1)
IE2: Borstar pilot plant with a 2-reactor set-up (loop1-loop 2) and a prepolymerization loop reactor. (MDPE-2)
CE1: Borstar pilot plant with a 3-reactor set-up (loop1-loop2-GPR 1) and a prepolymerization loop reactor. (HPDE-1)
MDPE-1, MDPE-2 and HDPE-1 were produced by using the polymerization conditions as given in Table 1.

TABLE 1
Polymerization conditions for MDPE-1, MDPE-2 and HDPE-1

| | MDPE-1 | MDPE-2 | |
|---|---|---|---|
| | (IE1) | (IE2) | HDPE-1 |
| Prepoly reactor | | | |
| Temp. (° C.) | 50 | 50 | 50 |
| Press. (kPa) | 5747 | 5693 | 5851 |
| C2 (kg/h) | 4.0 | 4.0 | 4.0 |
| H2(g/h) | 0.04 | 0.06 | 0.04 |
| C4 (g/h) | 86.3 | 84.8 | 75.0 |
| Split (wt %) | 3.5 | 6.7 | 3.7 |
| loop 1 Fraction (A-1) resp. | | | |
| component (X) for IE2 | | | |
| Temp. (° C.) | 85 | 85 | 85 |
| Press. (kPa) | 5550 | 5230 | 5445 |
| C2 conc. (mol %) | 5.4 | 4.8 | 4.3 |
| H2/C2 ratio (mol/kmol) | 0.78 | 0.23 | 0.59 |
| C4/C2 ratio (mol/kmol) | 3.8 | 25.5 | 3.8 |
| Split (wt %) | 21.5 | 42.0 | 19.9 |
| Density (kg/m3) of loop 1 | 960.0 | 934.6 | 958.8 |
| material (fraction (A-1), | | | |
| respect. Component (X)) | | | |
| MFR2 (g/10 min) of loop 1 | 30.0 | 0.4 | 14.9 |
| material (fraction (A-1), | | | |
| respect. Component (X)) | | | |
| loop 2 | | | |
| Temp. (° C.) | 85 | 85 | 85 |
| Press. (kPa) | 5356 | 5359 | 5390 |
| C2 conc. (mol %) | 5.3 | 4.2 | 4.0 |
| H2/C2 ratio (mol/kmol) | 0.87 | 0.20 | 0.34 |
| C4/C2 ratio (mol/kmol) | 2.0 | 27.0 | 1.2 |
| Split (wt %) | 23.9 | 51.3 | 22.0 |
| Density (kg/m3) after | 968.0 | 937.7 | 963.1 |
| loop 2 (component (A); | | | |
| respect. MDPE-2) | | | |
| MFR2 (g/10 min) after | 138.0 | 0.8 | 24.0 |
| loop 2 (component (A); | | | |
| respect. MDPE-2) | | | |
| MFR2 (g/10 min) of loop 2 | 676 | 1.6 | 39.4 |
| material (fraction (A-2)) | | | |
| respect. Component (Y) | | | |
| Density (kg/m3) of loop 2 | 976 | 940.7 | 967.6 |
| material (fraction (A-2)) | | | |
| respect. Component (Y) | | | |
| GPR | | Not used | |
| Temp. (° C.) | 80 | — | 85 |
| Press. (kPa) | 2000 | — | 2000 |
| H2/C2 ratio (mol/kmol) | 0.49 | — | 0.34 |
| C6/C2 ratio (mol/kmol) | 4.61 | — | — |
| Split (wt %) | 51.1 | — | 55 |
| MFR2 (g/10 min) of GPR | 0.003 | — | 0.06 |
| material (Component (B)) | | | |
| Density (kg/m3) of GPR | 913.9 | — | 953.1 |
| material (Component (B)) | | | |

The polymers were mixed with 0.05 wt % Irganox 1010 (BASF), 0.2 wt % Irgafos 168 (BASF) & 0.05 wt % CEASIT FI (Baerlocher) calcium stearate, where wt % are relative to total weight of composition (the sum of polymer powder+additive=100%) compounded and extruded on a ZSK 57 twin screw extruder. The melt temperature was 210° C., production rate was 200 kg/h.

TABLE 2
Material properties of MDPE-1, MDPE-2
and HDPE-1 as well as 40ST05,

| Material | MDPE-1 | MDPE-2 | HDPE-1 | 40ST05 |
|---|---|---|---|---|
| MFR₂ (g/10 min) (final) | 0.60 | 0.70 | 0.86 | 0.50 |
| MFR₂₁ (g/10 min) | 31.6 | 20.9 | 27.7 | 22.1 |
| MFR₂₁/MFR₂ (FRR) | 52.6 | 29.9 | 32.2 | 44.2 |
| Density (kg/m³) | 940.4 | 937.7 | 957.6 | 940.0 |
| Mz (g/mol) | 318500 | 274000 | 313500 | 214500 |
| Mw (g/mol) | 110000 | 113500 | 108500 | 99750 |
| Mn (g/mol) | 17400 | 33187 | 24450 | 26150 |
| Mz/Mw | 2.9 | 2.41 | 2.89 | 2.15 |
| Mw/Mn (MW) | 6.3 | 3.42 | 4.44 | 3.81 |
| FRR/(Mz/Mw) | 18.1 | 12.4 | 11.1 | 20.6 |
| FRR/MWD | 8.3 | 8.7 | 7.3 | 11.6 |

### Monolayer Blown Films

The above produced MDPEs (respectively the polymers used for the Comparative Examples) were blended with NAV 101 directly on the film extrusion line.

The following films have been produced with the above described method (film sample preparation).

TABLE 3
Composition and Properties of blown films

| | | IE1 | IE2 | CE1 | CE2 |
|---|---|---|---|---|---|
| NAV 101 | wt % | 70 | 70 | 70 | 70 |
| MDPE-1 | wt % | 30 | | | |
| MDPE-2 | wt % | | 30 | | |
| HDPE-1 | wt % | | | 30 | |
| 40ST05 | wt % | | | | 30 |
| TM/MD | MPa | 275 | 267 | 361 | 282 |
| TM/TD | MPa | 345 | 341 | 423 | 341 |
| DDI | g | 109 | 74 | 54 | 68 |
| Haze | % | 16.3 | 14.1 | 17.4 | 23.7 |
| OMA | | 1842 | 1404 | 1118 | 809 |

As can be seen from the above Table 3 the compositions using the metallocene catalysed MDPEs according to the present invention show the best balance between stiffness, impact and optics, i.e. haze. This leads to a clearly improved overall performance, i.e. improved OMA for films comprising the compositions according to the present invention compared to the Comparative Examples.
CE1 is based on a HDPE, thus stiffness is good, but impact is clearly worse, thus the overall performance is also worse.
CE2 is based on a MDPE, which provides similar stiffness as IE1 and IE2, but worse DDI and worse haze, thus having a clearly lower overall performance.

1-15. (canceled)

16. A composition comprising:
(I) 1.0 to 49.0 wt % based on a total weight of the composition of a metallocene catalysed medium density polyethylene (MDPE), wherein the metallocene catalysed MDPE has:
a density (ISO 1183) in a range of 932 to 955 kg/m³,
a MFR₂ (190° C., 2.16 kg, ISO 1133) in a range of 0.1 to 2.0 g/10 min,
a MFR₂₁ (190° C., 21.6 kg, ISO 1133) in a range of 10.0 to 40.0 g/10 min,
a ratio MFR₂₁/MFR₂ (FRR) in a range of 20.0 to 60.0,
a Mw/Mn (MWD) in a range of 2.5 to 7.0 and
a ratio of FRR/MWD in a range of 7.5 to 11.0; and
(II) 51.0 to 99.0 wt % based on the total weight of the composition of a mixed-plastic-polyethylene recycling blend (PERB) having:
a MFR₂ (ISO 1133, 2.16 kg, 190° C.) of from 0.1 to 1.2 g/10 min,
a density (ISO 1183) of from 910 to 945 kg/m³, and
a total amount of ethylene units (C2 units) of from 80.0 to 96.0 wt %, as measured by NMR of the d2-tetrachloroethylene soluble fraction,
with a total amount of C2 units being based on a total weight amount of monomer units in the mixed-plastic-polyethylene blend (B) and measured according to quantitative ¹³C{1H}NMR measurement;
whereby components (1) and component (II) of the composition add up to 100 wt %.

17. The composition according to claim 16 wherein the metallocene catalysed MDPE has:
a density (ISO 1183) in a range of 933 to 950 kg/m³, and/or 935 to 945 kg/m³; and/or
a MFR₂ (190° C., 2.16 kg, ISO 1133) of the metallocene catalysed MDPE in a range of 0.2 to 1.5 g/10 min, and/or 0.3 to 1.2 g/10 min, and/or 0.4 to 1.0 g/10 min; and/or
a MFR₂₁ (190° C., 21.6 kg, ISO 1133) in a range of 15 to 38.0 g/10 min, and/or in a range of 18.0 to 35.0 g/10 min, and/or 20.0 to 33.0 g/10 min; and/or
a Flow Rate Ratio (FRR), MFR₂₁/MFR₂ in a range of 22.0 to 58.0, and/or of 25.0 to 55.0; and/or
a molecular weight distribution (MWD), Mw/Mn, in a range of 2.8 to 6.8, and/or 3.0 to 6.5; and/or
a ratio of FRR/MWD in a range of 7.8 to 10.5, and/or 8.0 to 10.0.

18. The composition according to claim 16, wherein the metallocene catalysed MDPE has one or more or all of the following properties:
a weight average molecular weight, Mw, of at least 100000 g/mol, and/or in a range of from 109000 to 150000 g/mol, and/or from 109000 to 130000 g/mol, and/or from 109000 to 120000 g/mol; and/or
an average molecular weight, Mz, in a range of 215000 to 400000 g/mol, and/or 230000 to 380000 g/mol, and/or from 250000 to 350000 g/mol; and/or
a ratio of Mz/Mw in a range of 2.0 to 4.0, and/or 2.2 to 3.5, and/or 2.3 to 3.2; and/or
a ratio FRR/(Mz/Mw) in a range of 11.5 to 20.0, and/or 11.8 to 19.0, and/or 12.0 to 18.5.

19. The composition according to claim 16, wherein the metallocene catalysed MDPE comprises at least:
(i) 30 to 70 wt %, relative to the total weight of the MDPE, of a polyethylene component (A) with a density in a range of 950 to 980 kg/m³, and/or in a range of 955 to 975 kg/m³, and/or 960 to 972 kg/m³, and/or 962 to 970 kg/m³; and
a MFR₂ (190° C., 2.16 kg, ISO 1133) of 2 to 500 g/10 min, and/or in a range of 10 to 400 g/10 min, and/or 50 to 300 g/10 min, and/or 100 to 200 g/10 min; and
(ii) 30 to 70 wt %, relative to the total weight of the MDPE, of a polyethylene component (B) being a polyethylene with a density in a range of 900 to 925 kg/m³, and/or of 905 to 920 kg/m³, and/or 908 to 918 kg/m³, and/or 910 to 916 kg/m³; and
an MFR₂ (190° C., 2.16 kg, ISO 1133) of 0.0001 to 1.0 g/10 min, and/or of 0.0005 to 0.8, and/or of 0.001 to 0.5 g/10 min, and/or 0.002 to 0.1 g/10 min;
whereby polyethylene component (A) is an ethylene homopolymer and the polyethylene component (B) is an ethylene-1-hexene copolymer.

20. The composition according to claim 19, wherein the polyethylene component (A) is an ethylene homopolymer mixture comprising:
a first ethylene homopolymer fraction (A-1) and a second ethylene homopolymer fraction (A-2), whereby the ethylene polymer fraction (A-1) has:
a MFR₂ (190° C., 2.16 kg, ISO 1133) in a range of 5.0 to 100.0 g/10 min, and/or of 10.0 to 80.0 g/10 min, and/or of 15.0 to 50.0 g/10 min, and/or of 20.0 to 40.0 g/10 min; and
a density in a range of 945 to 970 kg/m³, and/or 950 to 965 kg/m³, and/or 952 to 962 kg/m³; and
the ethylene polymer fraction (A-2) has a MFR₂ (190° C., 2.16 kg, ISO 1133) in a range of 100.0 to 1500.0 g/10 min, and/or of 200.0 to 1200.0 g/10 min, and/or of 300.0 to 1000.0 g/10 min, and/or of 500.0 to 800.0 g/10 min; and
a density in a range of 960 to 980 kg/m³, and/or 965 to 980 kg/m³, and/or 970 to 978 kg/m³.

21. The composition according claim 16, wherein the metallocene catalysed MDPE consists of:
(i) 30 to 70 wt %, relative to the total weight of the MDPE, of a polyethylene component (X) with a density in a range of 920 to 950 kg/m³, and/or in a range of 925 to 945 kg/m³, and/or 928 to 942 kg/m³, and/or 930 to 940 kg/m³, and
a MFR₂ (190° C., 2.16 kg, ISO 1133) of 0.01 to 2.0 g/10 min, and/or in a range of 0.05 to 1.5 g/10 min, and/or 0.1 to 1.0 g/10 min, and/or 0.2 to 0.8 g/10 min; and
(ii) 30 to 70 wt %, relative to the total weight of the MDPE, of a polyethylene component (Y) being a polyethylene with a density in a range of 920 to 960 kg/m³, and/or of 930 to 955 kg/m³, and/or 935 to 950 kg/m³, and/or 938 to 945 kg/m³, and
a MFR₂ (190° C., 2.16 kg, ISO 1133) of 0.1 to 10.0 g/10 min, and/or of 0.5 to 6.0 g/10 min, and/or 0.8 to 4.0 g/10 min, and/or 1.0 to 2.5 g/10 min;
whereby both polyethylene components (X) and (Y) are an ethylene-1-butene copolymer.

22. The composition according to claim 16, wherein the mixed-plastic-polyethylene recycling blend (PERB) comprises:
a total amount of ethylene units (C2 units) of from 80.0 wt % to 96.0 wt %, and/or of from 82.5 wt % to 95.5 wt %, and/or of from 85.0 wt % to 95.5 wt %, and/or of from 87.5 wt % to 95.0 wt %;
a total amount of continuous units having 3 carbon atoms corresponding to polypropylene (continuous C3 units) of from 0.2 to 6.5 wt %, and/or from 0.4 wt % to 6.0 wt %, and/or from 0.6 wt % to 5.5 wt %, and/or from 0.75 wt % to 5.0 wt %;
wherein the total amounts of C2 units and continuous C3 units thereby are based on a total weight amount of monomer units in the mixed-plastic-polyethylene recycling blend (PERB) and are measured according to quantitative ¹³C{¹H} NMR measurement.

23. The composition according to claim 16, wherein the mixed-plastic-polyethylene recycling blend (PERB) comprises one or more in any combination, or all of:
a total amount of units having 3 carbon atoms as isolated C3 units (isolated C3 units) of from 0.00 wt % to 0.50 wt %, and/or from 0.00 wt % to 0.40 wt %, and/or from 0.00 wt % to 0.30 wt %, and/or from 0.00 wt % to 0.25 wt %;
a total amount of units having 4 carbon atoms (C4 units) of from 0.50 to 5.00 wt %, and/or from 0.75 wt % to 4.00 wt %, and/or from 1.00 wt % to 3.50 wt %, and/or from 1.25 wt % to 3.00 wt %;
a total amount of units having 6 carbon atoms (C6 units) of from 0.50 to 7.50 wt %, and/or from 0.75 wt % to 6.50 wt %, and/or from 1.00 wt % to 5.50 wt %, and/or from 1.25 wt % to 5.00 wt %;
a total amount of units having 7 carbon atoms (C7 units) of from 0.20 wt % to 2.50 wt %, of from 0.30 wt % to 2.00 wt %, and/or of from 0.40 to 1.50 wt %, and/or of from 0.45 wt % to 1.25 wt %, and
a LDPE content of from 20.0 to 65.0 wt %, and/or from 25.0 wt % to 62.5 wt %, and/or from 30.0 wt % to 60.0 wt %, and/or from 32.0 wt % to 55.0 wt %;
total amounts of C2 units, continuous C3 units, isolated C3 units, C4 units, C6 units, C7 units and LDPE content thereby are based on a total weight amount of monomer units in the mixed-plastic-polyethylene recycling blend (PERB) and are measured or calculated according to quantitative ¹³C{¹H} NMR measurement.

24. The composition according to claim 16, wherein the mixed-plastic-polyethylene recycling blend (PERB) has:
a MFR₂ (ISO 1133, 2.16 kg, 190° C.) in a range of 0.3 to 1.1 g/10 min; and/or
a density in the range of 915 to 942 kg/m³, and/or 918 to 940 kg/m³.

25. The composition according claim 16, wherein the composition consists of:
(I) 10.0 to 45.0 wt %, and/or 20.0 to 40.0 wt % of the metallocene catalysed medium density polyethylene (MDPE); and
(II) 55.0 to 90.0 wt %, and/or 60.0 to 80.0 wt % of the mixed-plastic-polyethylene recycling blend (PERB).

26. A composition according claim 16, whereby the film comprises:
at least 90 wt %, and/or at least 95 wt %, and/or at least 99 wt %, and/or consists of said composition.

27. The film according to claim 26, wherein the film has at least one or more or all of properties a) to c), wherein properties a) to c) are:
a) a dart-drop impact strength (DDI) determined according to ISO 7765-1:1988 on a 40 μm monolayer test blown film of at least 60 g up to 250 g, and/or 65 g up to 200 g, and/or 70 g up to 150 g; and/or
b) a haze measured according to ASTM D1003 on a 40 μm test blown film of below 22.0%, and/or in a range of 5.0 to 21.0%, and/or 10.0 to 20.0%, and/or 12.0 to 17.0%; and/or
c) a tensile modulus (measured on a 40 μm monolayer test blown film according to ISO 527-3) in machine (MD) as well as in transverse (TD) direction in a range of from >150 MPa to 500 MPa, and/or of from 200 MPa to 400 MPa.

28. The film according to claim 26, wherein the film has a property d) as follows:
d) an optomechanical ability (OMA) according to formula (II):
$$O M A = \frac{Tensile Modulus ( MD ) [ MPa ] * DDI ( g )}{Haze ( 40 μm ) [ \% ]}$$
determined on 40 μm test blown film is at least 1150 [MPa*g/%] up to 3000 [MPa*g/%], and/or in a range of from 1200 [MPa*g/%] up to 2500 [MPa*g/%], and/or in a range of from 1300 [MPa*g/%] up to 2000 [MPa*g/%], wherein a Tensile Modulus in machine direction is measured according to ISO 527-3 at 23° C. on 40 μm test blown films, DDI is a dart-drop impact strength determined according to ISO 7765-1:1988 on a 40 μm test blown film, and haze is measured according to ASTM D1003 on a 40 μm test blown film.

29. The film according to claim 26, wherein the film fulfils property d) and additionally at least property a), and/or property d) and additionally properties a) and b).

30. A film according to claim 26, configured as a packing material, and/or a secondary packaging material, which do not require a food approval, or a primary packaging for non-food products.
